(19) United States
(12) Patent Application Publication
(10) Pub. No.: US 2005/0069074 A1
(43) Pub. Date: Mar. 31, 2005

(54) Nuclear plant spent fuel low temperature reactor

(76) Inventors: Yulun Li, Beijing (CN); Fubang Ma, Beijing (CN); Yinghua Wu, Sichuan (CN)

Correspondence Address: LADAS & PARRY LLP, 224 SOUTH MICHIGAN AVENUE, SUITE 1200, CHICAGO, IL, 60604, US

(21) Appl. No.: 10/500,809

(22) PCT Filed: Jan. 6, 2003
(86) PCT No.: PCT/CN03/00006

(30) Foreign Application Priority Data
Jan. 8, 2002 (CN) 02100022.0
May 29, 2002 (CN) 02120704.6

(51) Int. Cl. G21G 1/06

(52) U.S. Cl. 376/170

(57) ABSTRACT

A low-temperature NPP spent fuel reactor is disclosed, wherein the core is located in the core vessel and is fuelled by NPP spent fuel; a sealing cover and/or an air-tight shield are located on the top of the pool, forming at least one air shield. A pressurizer is set on the coolant inlet nozzle that improves the static pressure and maintains the pressure at the core outlet. On the side of the pool is an underwater handling canal, which is connected with the spent fuel storage pond. This invention uses NPP spent fuel as its nuclear fuel, promoting the utilization value of uranium resource, with good safety, economical and environmental effects. The radioactive gases discharged to environment during normal operation and under accident conditions can meet the requirements of “no radiological consequence”. Its simplified handling process and equipment facilitate operation and improve safety. The reactor can be used for desalination, low-temperature heat supply and isotope production.

### FIELD OF TECHNOLOGY

This invention relates to a nuclear reactor technology, specifically to a low-temperature nuclear reactor using NPP spent fuel as its nuclear fuel.

### TECHNICAL BACKGROUND NPP spent fuel is the fuel, which reaches expected bum-up but is below its limit and can't meet the requirements of NPP operation and hence is discharged.

Generally, about 0.9-1.1% U-235 remains in the spent fuel assembly discharged from nuclear power plant and some fissile materials such as 0.6% Pu-239 and 15% Pu-241 are generated. They are usable resources.

At present, two kinds of basic policies are adopted for NPP spent fuel management in the world. One is “once-through” fuel cycle, whereby NPP spent fuel is directly disposed after interim storage without reprocessing. The second is spent fuel reprocessing, whereby the remaining U-235 and the generated Pu-239 in spent fuel are extracted through reprocessing and fabricated into MOX element to be reused as NPP fuel. Obviously, uranium resource is not utilized sufficiently in “once-through” fuel cycle. Although uranium utilization is improved by reusing the remaining U-235 and newly generated Pu-239 through reprocessing as NPP fuel, the reprocessing cost is quite high.

In order to make fully use of these resources, Canada, South Korea and US are working together to develop a new technology, whereby the PWR spent fuel core pellets are reprocessed and fabricated into CANDU fuel elements for continual use in PHWR NPP. That is “DUPTC” project, in which technology is very complicated, with high cost and under development.

In addition, the utilization of decay heat and gamma from spent fuel is considered.

NPP operation practices and fuel assembly irradiation tests have showed that spent fuel doesn't reach its bum-up limit. Therefore spent fuel can be directly used as long as spent fuel assemblies are properly examined and evaluated. This invention uses spent fuel to make core with low parameters heating reactor and thereby to utilize its fission energy.

The low-temperature reactor is a kind of reactor, whose core consists of fuel assemblies, normal temperature and pressure coolant and moderator. Fission heat is taken out of the core by the normal temperature and pressure coolant flowing through the fuel assemblies, low-temperature hot water is supplied to customers through heat exchanger, and water layer is mainly used as neutron moderation and radiation shield. The core is made up of the fuel assemblies, the upper and lower core grid plates, and the control rod and its drive mechanism. The fuel assemblies are fixed with the upper and lower core grid plates. The control rod is inserted from the top of the core into the lattice made up of the upper and lower core grid plates and fuel assemblies. The upper end of the control rod is connected with its drive mechanism. The core is located in the core pool, where there are coolant inlet and outlet nozzles, which are connected with the heat exchanger through pipes. The core heat is carried out through coolant to supply hot water without any radioactivity to the heat network.

The low-temperature reactors that have been designed and constructed in the world can be divided into two types. One is the metal containment pressurized reactor, featured by the natural circulation boiling water reactor designed and constructed by West Germany and Russia, whose core is located in the pressure-resistant vessel and the in-core structure is alike to the power reactor. The other is pressure bearing pre-stressed concrete containment reactor, for example the low-pressure pressurized water reactor designed by Sweden. There are also two kinds of low-temperature reactors in China, i.e. pressure vessel and pool types. In all the low-temperature reactors at home and abroad, unirradiated nuclear fuel is used.

Nuclear heat supply is an important means for heating and desalination. Though many design concepts of low-temperature heat supply reactor exist at home and abroad, they have not been widely accepted in context of economics and safety. So low construction cost and reliable safety are decisive factors in promoting nuclear heat supply reactor. This invention can properly ensure the economics and safety of low-temperature heating reactor.

### SUMMARY OF INVENTION

This invention is aimed at supplying a low-temperature and low-pressure reactor, which directly uses NPP spent fuel for desalination, heat supply and isotope production, and is featured with low construction cost and good safety and reliability.

The technical option to realize this invention is: a low-temperature NPP spent fuel reactor, wherein the core is made up of the fuel assemblies, the upper and lower core grid plates, and the control rod and its drive mechanism. The fuel assemblies are fixed with the upper and lower core grid plates. The control rod is inserted from the top of the core into the lattice made up of the upper and lower core grid plates and fuel assemblies. The upper end of the control rod is connected with its drive mechanism. The core is located in the core vessel under the core pool, where there are coolant inlet and outlet nozzles, which are connected with the heat exchanger through pipes. The core is fuelled by NPP spent fuel. The sealing cover, on the upper of the core pool, is filled with much pressurized gas and constitutes a pressurized air cavity and primary air shield. Additionally, on the top of the core pool there is an airtight shield to form secondary air shield. Within the core pool there is an underwater handling canal, which is connected with the spent fuel storage pond and replaces addition of reloading water layer with under water handling canal refueling scheme. The residual heat cooler in the spent fuel storage pond and the magnetic valve on the connection tubes constitute the passive residual heat removal system.

In the low-temperature and low-pressure reactor, NPP spent fuel is directly used as nuclear fuel. The core can not only reach criticality, but also has much backup reactivity to meet operation requirements. The backup reactivity mainly stems from:
1. The temperature reduction can produce positive reactivity, when NPP high parameters are changed into low parameters;
2. The equilibrium xenon toxicity absorption reactivity reduction can also produce positive reactivity, when power density is reduced (neutron flux reduction);
3. Appropriate moderate reflector is added around the core as necessary to reduce neutron leakage and increase backup reactivity;
4. Because of the slag existing in the core consisting of the spent fuel, Sm-149 and Sm-151 absorb neutron de-poisoning and produce positive reactivity during operation to extend operation lifetime.

Core loading nuclear designs as well as thermal calculation show that the low-temperature and low-pressure reactor consisting of NPP spent fuel has the following safety features:
1. Temperature coefficient is negative value under condition from cold state to hot state.
2. The volume of assembled core is large and power density is low, only 1/12-1/15 of the power density of the nuclear power plant. The highest temperature of fuel matrix is only 400° C. at nominal power. Together with inherent safety and passive safety features, the core will not be melted down in case of severe accidents.
3. Because more than one airtight shields are used to prevent radioactive gases released into the atmosphere and the radioactive gases are treated effectively, the level of “no radiological consequence” to the environment specified by the regulations is satisfied.

The effects of the patent are as follows:
1. The neutron chain reaction device that reuses the spent fuel from the nuclear power plant as nuclear fuel promotes the utilization value of uranium resource without any new spent fuel production. The fuel assemblies discharged from the nuclear power plant can be loaded into the reactor followed by proper inspection. Therefore, the costs of fuel as well as investment and operation are significantly reduced, economic and environmental effects are remarkable.
2. Because of low power density and passive residual heat removal, the core will not be melt down in case of accidents. With at least one airtight shield and “no radiological consequence”, this reactor is of high inherent safety and good safety performance.
3. Because the NPP spent fuel core has much backup reactivity and fully satisfies the requirements for nuclear heat supply, the produced heat can be used for desalination, district heating and non-carrier radioisotope production.
4. Technically special underwater fuel handling canal is used to replace conventional fuel handling system. The simplified handling process and equipment facilitate operation and enhance safety.

### DESCRIPTION OF FIGURES

FIG. 1 The Schematic Diagram of Low-temperature NPP Spent Fuel Reactor (Pressurizer Pressurization)

FIG. 2 The Schematic Diagram of Low-temperature NPP Spent Fuel Reactor (Air Cavity Pressurization)

### In Figures:

1.support skirt 2. lower core grid plate 3. fuel assembly 4. core vessel 5. upper core grid plate 6. control rod and its drive mechanism 7. concrete biological shield 8. core pool 9. coolant inlet nozzle 10. coolant outlet nozzle 11. sealing cover 12. secondary airtight shield 13. pressurizer 14. handling canal 15. spent fuel storage pond 16. handling carriage 17. pressurized air cavity 18. electromagnetic valve 19. residual heat cooler

### MODE OF CARRYING OUT THE INVENTION

EXAMPLE 1

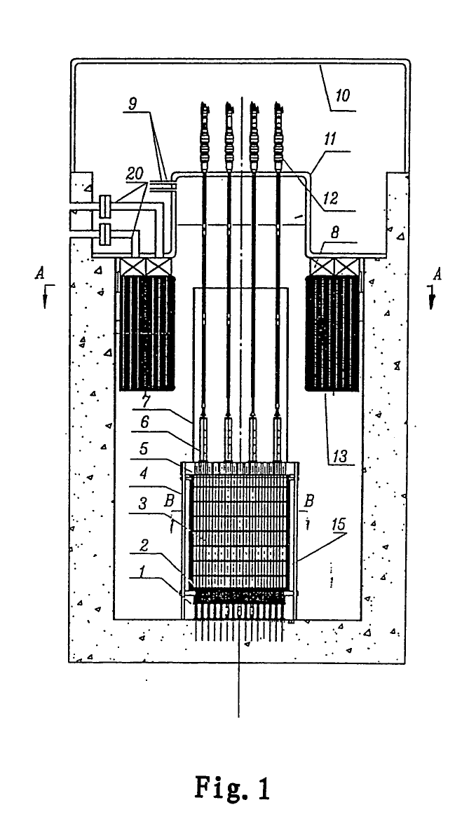

This invention takes example for a 200 MW(t) heating supply reactor, as shown in FIG. 1. The concrete biological shield (7) is used to enclose the core pool (8) and the spent fuel storage pond (15). The coolant inlet and outlet nozzles (9, 10) are set on the upper part of the core pool (8). On the side of the core pool (8) is a underwater handling canal (14), which is connected with the spent fuel storage pool (15) and is plugged with a sealing plug when the reactor is in operation to ensure the core pond (8) isolated from the spent fuel storage pond (15). The spent fuel shipping casks and the fuel storage racks may be located in the spent fuel storage pond (15), with a handling carriage (16). The canal is open in case of handling to transport the spent fuel assemblies. The concrete biological shield (7) is covered with a layer of stainless steel to prevent the pool from leakage. The core vessel is located on the lower of the core pool (8). The core is made up of the fuel assemblies (3), the upper and lower core grid plates (5,2), and the control rod and its drive mechanism (6). The fuel assemblies (3) are fixed with the upper and lower core grid plates (5,2). The control rod is inserted from the top of the core into the lattice made up of the upper and lower core grid plates (5,2) and fuel assemblies. The upper end of the control rod is connected with its drive mechanism. The core is located in the core vessel (4) under the core pool (8). The fuel assemblies are the spent fuel assemblies discharged from nuclear power plant, and are configurated by the burn-up of different groups of spent fuel assembly. When backup reactivity is needed, the spent fuel assembly with deep burn-up is arranged in the center of the core and the spent fuel assembly with light burn-up in the periphery of the core. Graphite reflector is arranged around the core as appropriate to reduce neutron leakage and improve backup reactivity. When radial power distribution is needed to flatten out, the spent fuel assemblies are arranged in reverse. The fuel assemblies are inserted in the lower core grid plate (2) and are pressed and fixed by the upper core grid plate (5) to prevent the fuel assemblies from moving up and down. The lower end of the core is supported by the support skirt. There are two kinds of core configurations. FIG. 1 shows the pressurizer under static pressure. The coolant inlet nozzle (9) is connected with a pressurizer (13), which is located on higher position to form core outlet pressure. The core vessel (4) in the core pool (8) is full filled with water, the core vessel and the coolant circuit constitute primary boundary to prevent radioactive water spilling. The drive mechanism is fixed on the sealing cover (11) located on the upper of the core pool and connected with the control rod. At the top of the core pool (8) is an airtight shield (12). The area between the sealing cover (11) of the core pool (8) and the airtight shield extracts negative pressure and constitutes an airtight shield to prevent radioactive gases from releasing into the environment. The residual heat cooler (19) is located in the spent fuel storage pond (15). The electromagnetic valve (18) is located on the connection tubes. In case of loss of external power supply, the electromagnetic valve (18) is automatically off and opens. The hot water flows through the tube of the residual heat cooler (19) and is cooled by the water from the spent fuel storage pond (15), constituting twin natural circulation and heat exchange. The spent fuel storage pond is a final heat sink. When temperature is too high, the heat is carried away or cooled by a forced way.

### EXAMPLE 2

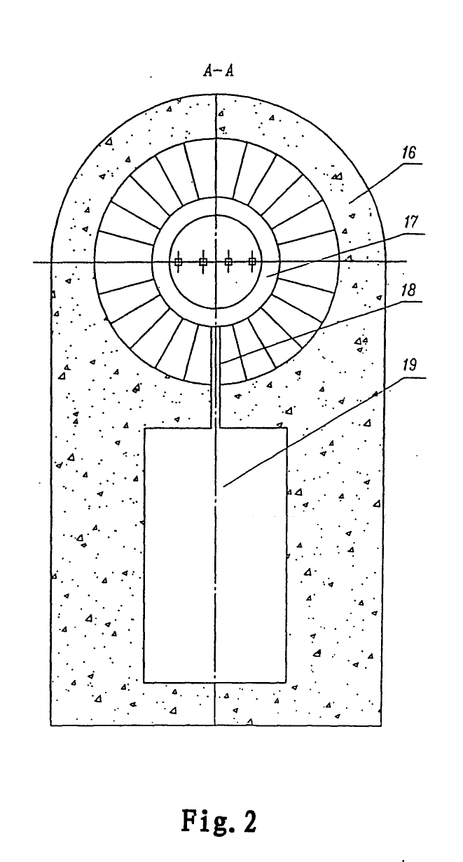

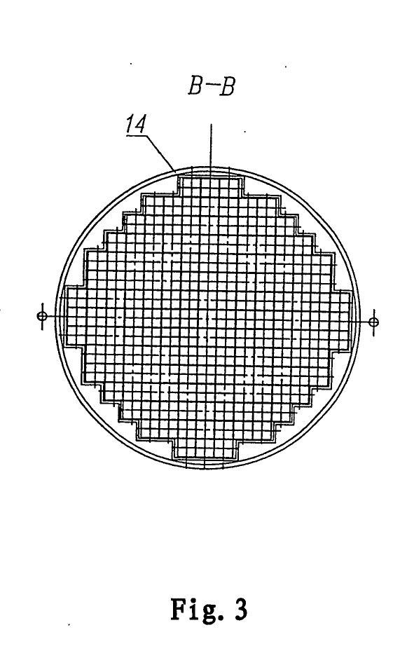

Unlike example 1, another configuration is core pool filled with full of air, the atmosphere is used to form pressure at outlet, as shown in FIG. 2. A sealing cover (11) like a cap is located on the top of the core pool (8) to form pressurized air cavity (17), which is filled with pressurized air or nitrogen or helium. On the lower part is the water level fluctuation area to form an airtight shield. Meanwhile, on the top of the core pool there is an airtight shield to form secondary air shield. The area between the sealing cover on the top of the core pool and the airtight shield extracts negative pressure to prevent radioactive gases from releasing.

In order to remove the hydrogen and oxygen from water decomposition within the sealing cover and the gaseous iodine and radioactive noble gases from fuel fission, the invention designs an air circulation circuit (not shown in the figure) to recombine hydrogen and oxygen as well as removing iodine and noble gases out.

The core is cooled by cooling water flowing out of the core through support skirt, lower core grid plate, fuel assembly and the upper core grid plate, then flowing into the primary heat exchanger, water pump and the core inlet through the core outlet to form forced circulation. The heat from primary water is transmitted to the intermediate circuit and then to the third circuit through secondary heat exchanger. The hot water or steam from the third circuit can be used for heating or desalination.

If this invention is designed for isotope production, the target object can be located into the control rod or the irradiation tubes.

Take an example for Qinshan NPP spent fuel assembly swimming pool reactor with normal temperature and pressure (1 bar at the surface of the pool and the average temperature under 100° C.), 121 spent fuel assemblies (the same number as that in the core of Qinshan nuclear power plant) are used, with light water as both coolant and moderator, and thermal power is 200 MW. The effective multiplication factor for the neutron chain reaction device is about 1.05, and the heat, neutron and gamma produced by the device can be used in relative fields.

(1)If the device is designed for heating, it can continually operate for 600 full power days, the fission heat from 121 spent fuel assembly can supply an area of 5 million m² for 4 years;

(2)If the device is designed for low-temperature (72° C.) supply for low-temperature multi-effect distillation seawater desalination, it can, produce 80 000 tons fresh water (high quality water with 5 ppm salt content) daily, continually operate for 600 days at full capacity, and a total of 48 million tones high quality fresh water can be produced by the 121 spent fuel assemblies.

1. A low-temperature NPP spent fuel reactor, wherein the core comprises fuel assembly, upper and lower core grid plates, control rod and its drive mechanism; the fuel assemblies are fixed through the upper and lower core grid plates; the control rod is inserted from the upper of the core into the lattice made up of the upper and lower core grid plates and the fuel assemblies; the top of control rod is connected with its drive mechanism; the core is located in the core vessel, where there are coolant inlet and outlet nozzles, connected with each other through tube and heat exchanger; wherein the said reactor is fuelled by NPP spent fuel.

2. The low-temperature NPP spent fuel reactor according to claim 1, wherein on the top of the core pool are the sealing cover and/or the airtight shield to constitute at least a gas shield.

3. The low-temperature NPP spent fuel reactor according to claim 1, wherein on the coolant inlet nozzle is provided a pressurizer or a large pool to improve the static pressure and maintain the pressure at the core outlet.

4. The low-temperature NPP spent fuel reactor according to claim 1, wherein within the core pool there is an underwater handling canal, which is connected with the spent fuel storage pond and replaces addition of reloading water layer.

5. The low-temperature NPP spent fuel reactor according to claim 1, wherein the residual heat cooler in the spent fuel storage pond and the electromagnetic valve on the connection tube constitute the passive residual heat removal system.
